(19) United States
(12) Patent Application Publication
(10) Pub. No.: US 2011/0124421 A1
(43) Pub. Date: May 26, 2011

(54) METHOD FOR PRODUCING A TUBULAR DRIVE SHAFT, IN PARTICULAR A CARDAN SHAFT FOR A MOTOR VEHICLE

(76) Inventors: Christine Kienhofer, Niefern-Oschelbronn (DE); Eckhard Morlock, Konigsbach-Stein (DE); Andreas Becker, Pforzheim (DE); Eberhard Rauschnabel, Karlsbad (DE)

(21) Appl. No.: 10/581,399

(22) PCT Filed: Dec. 2, 2004
(86) PCT No.: PCT/EP2004/013702

§ 371 Date: Jul. 3, 2007

(30) Foreign Application Priority Data
Dec. 3, 2003 (DE) 203 19 05.3
Jan. 27, 2004 (DE) 10 2004 005 096.1

(51) Int. Cl. F16C 3/02; B21C 37/00

(52) U.S. Cl. 464/183; 72/370.25

(57) ABSTRACT

A method for producing a tubular drive shaft is described, comprising a first section with a first diameter and a second section with a second diameter, said second diameter being smaller than the first diameter, and a transition section in which a diameter of said drive shaft diminishes from the first diameter to the second diameter and which is provided with an annular bead which coaxially surrounds a longitudinal axis of said drive shaft, and in the process of which method, a tube with the first diameter is reshaped and reduced in diameter to form the second section and the transition section.

According to the invention it is provided that the bead is formed during, after, or during a break in the reshaped process that results in the production of a second section with a second diameter.

The invention relates to a method with the features specified in the pre-characterizing part of claim 1.

From DE 41 13 709 C2 a cardan shaft is known, which has a first section with a first diametre and a second section with a second diametre, the second diametre being smaller than the first diametre. Between the first section and the second section there is a transition section in which the diametre diminishes from the larger first diametre to the smaller second diametre. This design has the purpose, that when the motor vehicle crashes into an obstacle, the cardan shaft can be telescoped with as less energy consumption as possible by the first section of the cardan shaft with the larger diametre being pushed onto the second section of the cardan shaft with the smaller diametre under deformation of the transition section.

In this connection the danger exists, that the cardan shaft buckles. This is undesirable because the buckling would result in uncontrolled deformation characteristics. Therefore DE 41 13 709 C2 discloses to provide a pipe socket in the cardan shaft, a section of the pipe socket of a smaller diametre being tightly fit in a second section of the cardan shaft with the smaller diametre. Therefrom the pipe socket extends into the first section of the cardan shaft with the larger diametre and there has a section with a diametre, which is approximated to the inner diametre of the first section of the cardan shaft. When in case of a crash the two sections of the cardan shaft telescope, the pipe socket should effect a guidance preventing buckling of the cardan shaft, such that the cardan shaft only accommodates deformation energy until its second section tears off from its first section.

Moreover it is known to further develop a cardan shaft of the type described in DE 41 13 709 C2 such that there is an annular bead, which is coaxial to the longitudinal axis of the cardan shaft, at the outer surface of the transition section between the first section with a larger diametre and the second section of the cardan shaft with a smaller diametre. By means of this bead it shall be determined at which position the transition section in case of a crash begins to corrugate and later tears off. It is known to produce such a cardan shaft with a bead in the transition section by starting from a tube having the diametre that the cardan shaft is meant to have in its first section. The bead is rolled or turned into this tube by acting upon the tube in a radial direction at the position at which later the transition portion shall be located. Subsequently the second section of the cardan shaft with the smaller diametre and the transition section are formed by rotary swaging, drawing or pressing the tube. After that, the prefabricated pipe socket is inserted through the first section of the cardan shaft into this cardan shaft and pressed into its second section, i.e. the section with the smaller diametre.

Despite the bead, the deformation characteristics of cardan shafts manufactured in such a way are subject to variations which are undesirably large. The variations are undesirable because they render forecasts concerning the deformation characteristics and constructive measures which depend on this forecasts for achieving a given degree of passive security of the motor vehicle more difficult.

It is the object of the present invention to show a way to decrease variations of deformation characteristics of drive shafts of the above-mentioned kind without loss of security.

This object is achieved by a method with the features of claim 1 and by a drive shaft produced according to the method. Advantageous further developments of the invention are subject matter of the dependent claims.

According to the invention, a bead is not rolled or turned into the tube, of which the drive shaft is to be formed, until the tube is reshaped in order to form a second section with a smaller diametre in addition to a first section with a larger diametre. According to the invention the bead is rather formed during the reshaping process or after the reshaping process or during a break of the reshaping process which results in the production of the second section of the drive shaft with the smaller second diametre d. This has substantial advantages:
The position of the bead in the transition section of the drive shaft can be determined more precisely.
The shape of the bead can be determined more precisely.
The dimensions of the bead, especially its depth, can be determined more precisely.
The bead excels in a higher regularity.
The danger of an excentric position of the bead is decreased.
Reshaping the tube in order to form the second section with the smaller diametre d, which can be effected particularly by rotary swaging or drawing, does not change the position, the shape and the dimensions of the bead or at least less than in case of the application of the known method.
The deformation characteristics of the drive shaft are less then commonly subjected to variations.
Guaranteeing a given degree of passive security in the motor vehicle is facilitated.
The costs of the method according to the invention have approximately the same dimension as the costs of the known method or less.
When applying the method according to the invention, a locally varying hardness, which can occur for example in the section of a line of welding, affects only minimally on variations of the depth of the bead.

Particularly appropriate as methods to reshape the tube in order to achieve a section of smaller diametre and a transition section to the first section with the larger diametre are at least one of rotary swaging and drawing.

The bead is preferably formed at the outer surface of the transition section. For this there are several possibilities and it facilitates the control of the result of manufacturing. However, depending on the method which is selected for forming the bead, it is also possible to form the bead at the inner surface of the transition section; a bead provided at the inner surface can be more favourable for turning inside out and tearing off the tube of which the drive shaft is formed than a bead provided at the outer surface of the transition portion. At the inner surface a bead has especially taken into account, if it is to be pressed into the transition portion. The preferred way to form the bead is to press the bead into the transition portion. Another possibility to form the bead by chipless manufacturing is to roll it into the transition portion. If the tube is to be reshaped by rotary swaging, a favourable possibility to form the bead is to use swaging jaws which are provided with a protrusion at their front face by which they act upon the tube, the contour of which protrusion reproduces itself in the created transition section of the drive shaft.

But it is also possible—although not preferred—to form the bead at the outer surface by chip-removing manufacturing, particularly by turning.

The bead can not only be formed at the inner surface or the outer surface of the transition portion but also at both surfaces, particularly congruent. In this case the beads together are appropriately as deep as the bead in case that it is provided as the only one in the transition section.

If there is only one bead provided in the transition section it preferably is formed with a depth of 0.15 mm to 0.3 mm, in particular 0.2 mm. This has proven to be appropriate for the purpose of the bead and also takes into account that it is the true object of the drive shaft to transmit torques. If there are provided two congruent beads—one at the inner surface and one at the outer surface—their depth should appropriately be approximately 0.15 mm to 0.3 mm all together.

The forces mooing while forming the bead are preferably accommodated by a counter bearing which is temporarily put to the transition section of the drive shaft at its face opposite to the bead. In this way a bead is obtained which is particularly regular in shape and depth and therefore particularly advantageous for the purposes of the invention. But it is also possible to form a bead which does not extend to an angle of circumference of 360° without interruptions but which is interrupted at several places. These places are preferably disposed regularly along the circumference of the transition section. They enable transmitting of higher torques while simultaneously serving the object of the bead, which is tearing off and turning inside out of the drive shaft at the determined position in case of a crash.

Embodiments of the invention are shown in the appended drawings in which same or similar parts are designated by same reference numbers.

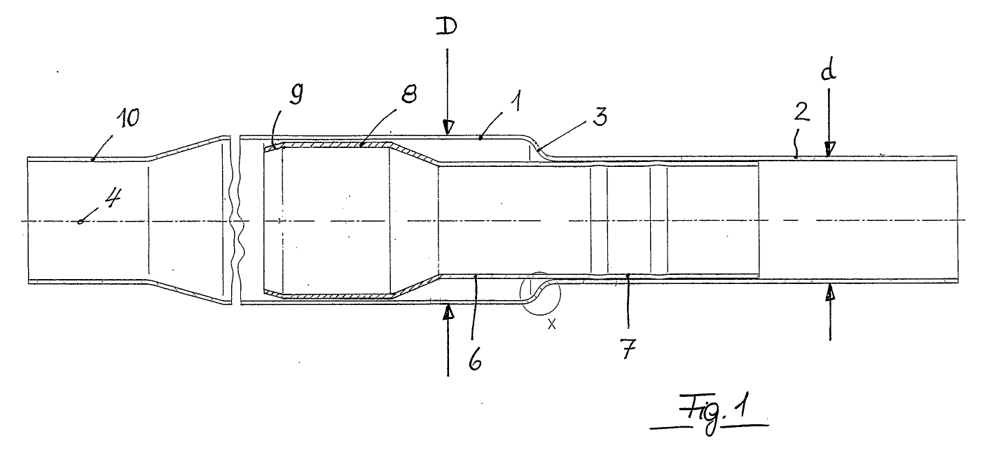

FIG. 1 shows a cross section in a longitudinal direction of a drive shaft which is produced according to a method according to the present invention,

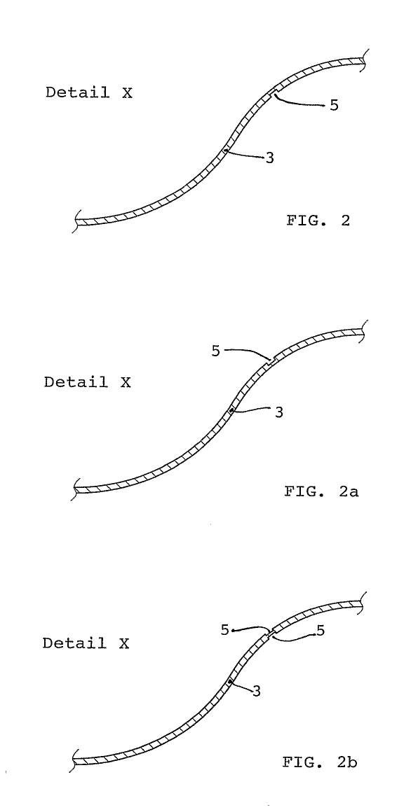

FIG. 2 shows the detail X of FIG. 1,

FIGS. 2a and 2b show modifications of FIG. 2,

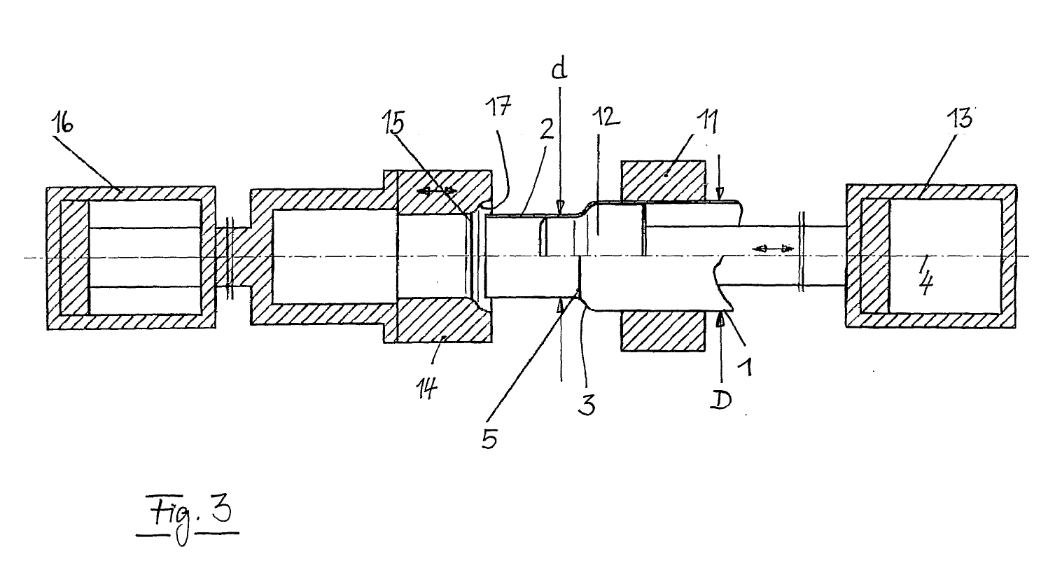

FIG. 3 shows a cross section in a longitudinal direction of a drive shaft with tools for forming a bead,

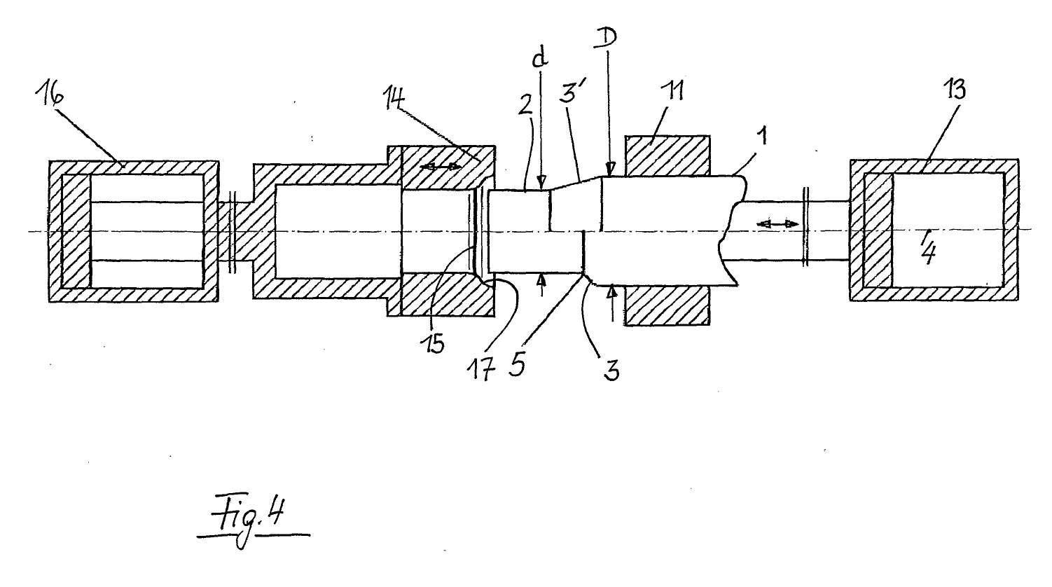

FIG. 4 shows an illustration according to FIG. 3 of a second example for manufacturing a bead in the drive shaft,

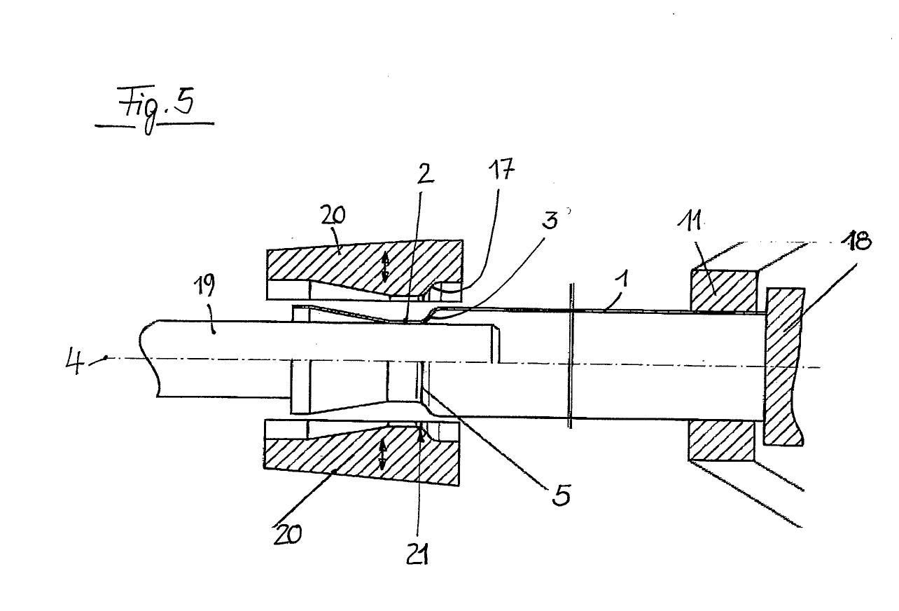

FIG. 5 shows an illustration according to FIG. 3 of a third example for forming a bead into a drive shaft, and

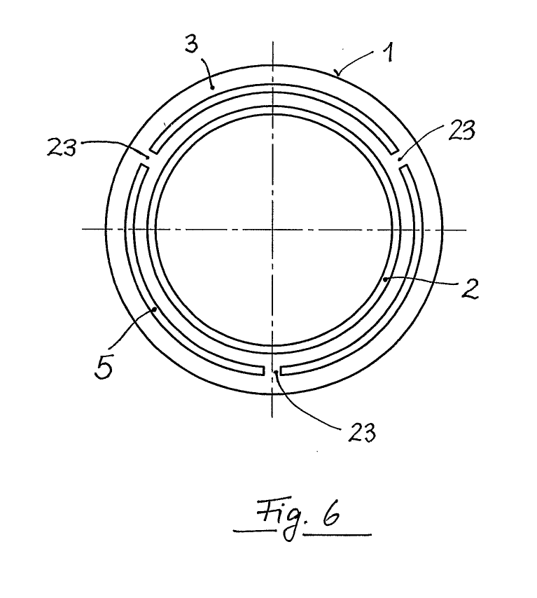

FIG. 6 shows—in a view of the transition section of the drive shaft—a bead with interruptions as a modification of the example of FIG. 1.

The drive shaft shown in FIG. 1 is formed commencing from a cylindrical tube with an outer diametre D. First this tube is worked by reshaping, particularly by drawing or rotary swaging a part of its length. Hence, a first section 1 of the tube keeps its original outer diametre D and a second section 2 is produced with a second smaller outer diametre d. For section 1 being able to telescope upon the section 2 in case of a crash or far section 2 being able to telescope into the section 1, the outer diametre d is at least the thickness of the wall of the first section 1 smaller than the inner diametre of the section 1. Between the sections 1 and 2 there is a transition section 3 with an approximately S-type shape in cross section in a longitudinal direction. The slope of this transition portion 3 is preferably from 45° to 80° to the longitudinal axis 4 of the drive shaft. At the outer surface of the transition portion 1 an annular bead 5 is formed, which is coaxial with regard to the longitudinal axis 4. FIG. 2 shows which shape the bead 5 formed in such a way has in the embodiment. Since it has only a depth of approximately 0.2 mm, it is shown in FIG. 2 in an exaggerated way. FIGS. 2a and 2b show alternatives of FIG. 2. In FIG. 2a the bead 5 is not disposed at the outer surface but at the inner surface of the transition section 3. In FIG. 2b there is a bead 5 at both surfaces of the transition section 3, which are disposed approximately congruent and only about half as deep as shown in the embodiments according to FIGS. 2 and 2a.

A pipe socket 6 with a thinner neck 7 and a thicker section 8 terminating in a tapered short section 9 has its neck 7 being tightly fit within the second section 2 of the drive shaft. The outer diameter of the neck 7 is adapted to the inner diametre of the second section 2 of the drive shaft, such that when inserting the neck 7 into the second section 2 there results a tight fit by which the pipe socket 6 is fixed in the drive shaft. The outer diametre of the thicker section 8 of the pipe socket 6 is approximated to the inner diametre of the section 1 of the drive shaft such that there is a guidance between both of them when in case of a crash the sections 1 and 2 of the drive shaft are telescoped into each other. But the invention also includes drive shafts for which a pipe socket 6 is not provided.

With regard to FIG. 3 it is now described how such a bead 5 is formed into the transition section 3 of a drive shaft. For that the drive shaft is fixed in its first section 1 by means of a clamping device 11.

From the side of the first section 1, preferrably—for example—a counter bearing 12 is appropriately inserted into the drive shaft, the counter bearing 12 having a contour adapted to the silhouette of the inner surface of the drive shaft at the transition section 3 and in adjacency to the transition portion 3. The counter bearing 12 is pressed against the inner surface of the transition section 3 by means of a first pressure cylinder 13. By means of a hollow punch 14 having an annular corrugation 15 at its front face and being pushed upon the second section 2 of the drive shaft coaxially with regard to a longitudinal axis 4, an annular bead 5 being complementary to the annular corrugation 15 is pressed into the transition section 3. For that, a second pressure cylinder 16 acts upon the punch 14. On both sides of the annular corrugation 15 the punch 14 has a contour 17 at its front face, which is complementary conform to the contour which the drive shaft shall have at the outer surface of its transition section 3 and in adjacency thereof. If the drive shaft has the desired contour already before forming the bead 5 in the portion of the transition section 3, the cooperation of the punch 14 with the counter bearing 12 insures that the desired contour is not changed but maintained while forming the bead 5.

However, if the drive shaft before forming the bead 5 has a contour in the portion of the transition section 3, which still differs from the desired contour, the portion of the transition section 3 then receives its final contour by pressing it between the punch 14 and the counter bearing 12; in this case the contour of the front face of the punch 14 has the function of a matrix, in which the transition section 3 of the drive shaft is pressed and calibrated by the cooperation of the punch 14 and the counter bearing 12.

A modification of the such formed annular bead 5 is shown in FIG. 6. With this modification the bead is interrupted at three places. The interruptions are disposed in steps of 120°. They allow transmitting of higher torques while maintaining the effect of tearing off and turning inside out of the outer tube of the drive shaft at a determined position.

The embodiment according to FIG. 4 differs from that of FIG. 3 in that the contour of the transition section 3 still differs more evidently from the desired final contour. Between the first section 1 with the outer diametre d and the second section 2 with the outer diametre d there is, as a preform, for example a conical transition portion 3′, which comprises an even larger length than the desired final contour of the transition section 3 has, which is shown in the lower half of the drawing of FIG. 4. In this case the final contour of the transition section 3 is formed by the cooperation of the punch 14 and the counter bearing 12 and simultaneously the bead 5 is formed.

The embodiment shown in FIG. 5 differs from the embodiments shown in FIGS. 3 and 4 in, that the tube which is to be formed into a drive shaft and which is fixed in a clamping device 11, at its end is positioned at a stop 18. A cylindrical mandrel 19 is inserted into the tube from the opposite side, wherein the outer diametre of the mandrel 19 is similar to an inner diametre which the second section 2 of the drive shaft shall receive. This second section 2 is formed by rotary swaging against the mandrel 19. For this purpose two swaging jaws 20 are schematically shown in FIG. 5. At their end facing towards the stop 18 they have a contour 17 which corresponds to the desired contour in the portion of the transition section 3 to be formed. For this the swaging jaws 20 at their contour additionally have sections 21 of an annular corrugation. By means of them acting upon the fixed tube and simultaneously swaging the transition section 3 the bead 5 is formed.

The second section of the drive shaft with the diametre d, which is located in greater distance from the transition section 3 can also be formed by pressing instead of rotary swaging.

If the second section 2 and the transition section 3 of the drive shaft have been formed, a pipe socket 6—as shown in FIG. 1—can be inserted through the first section 1, which is larger in diametre and can be fixed by pressing it into the second section 2.

Not until the pipe socket 6 has been inserted according to the illustration in FIG. 1, a third section 10 of the drive shaft, which is facing away from the second section 2, is formed by reshaping, particularly by drawing or rotary swaging, starting from the outer diametre D of the first section 1. The third section 10, which with regard to FIG. 5 is formed in a section of the tube adjacent to the stop 18, has preferably, but not necessarily, the same diametre d, which the second section 2 has, too. Between the first section 1 and the third section 10 another transition section 22 is obtained, in which according to the invention another bead can be formed, the objective of which is similar to the objective of the bead 5 at the transition section 3.

### LIST OF REFERENCE NUMBERS

1. first section
2. second section
3. transition section
3′. conical transition section
4. longitudinal axis
5. bead
6. pipe socket
7. neck of 6
8. thicker section of 6
9. tapered section of 8
10. third section
11. clamping device
12. counter bearing
13. first pressure cylinder
14. punch
15. annular corrugation
16. second pressure cylinder
17. contour
18. stop
19. cylindrical mandrel
20. swaging jaws
21. section of an annular corrugation
22. another transition section
23. interruptions

1. A method for producing a tubular drive shaft, comprising a first section with a first diameter and a second section with a second diameter, said second diameter being smaller than said first diameter, and a transition section in which a diameter of said drive shaft diminishes from said first diameter to said second diameter and which is provided with an annular bead which coaxially surrounds a longitudinal axis of said drive shaft, and in the process of which method a tube with said first diameter is reshaped and reduced in diameter to form said second section and said transition section,
characterized in that said bead is formed during, after, or during a break in said reshaping process that results in the production of said second section with said second diameter.

2. The method according to claim 1, characterized in that said tube is reshaped by at least one of rotary swaging or drawing.

3. The method according to claim 1, characterized in that said bead is formed at an outer surface of said transition section.

4. The method according to claim 1, characterized in that said bead is formed at an inner surface of said transition section.

5. The method according to claim 1, characterized in, that a first bead is formed at an outer surface and a second bead is formed at an inner surface of said transition portion.

6. The method according to claim 1, characterized in, that said bead is formed such that it extends along a whole circumference of said transition portion without interruption.

7. The method according to claim 1, characterized in that said bead is formed, such that it extends along a circumference of said transition section with interruptions.

8. The method according to claim 1, characterized in that said bead is formed by a chip-removing technique, in particular by turning.

9. The method according to claim 1, characterized in that said bead is formed by a chipless technique.

10. The method according to claim 9, characterized in that said bead is rolled into said transition portion.

11. The method according to claim 9, characterized in that said bead is pressed into said transition portion.

12. The method according to claim 9, characterized in that said bead is formed by rotary swaging.

13. The method according to claim 1, characterized in that said bead has a depth of 0.15 mm to 0.3 mm.

14. The method according to claim 1, characterized in that a force, which acts upon said transition portion while forming said bead has a component parallel to a longitudinal axis of said drive shaft.

15. The method according to claim 14, characterized in that said component of said force which is parallel to said axis is larger than a radial component of said force.

16. The method according to claim 14, characterized in that said force acts only parallelly to said axis.

17. A method according to claim 1, characterized in that while forming said bead into said transition section, in particular while forming said bead by pressing, occurring forces are accommodated by a counter bearing, which is temporarily put to said transition portion at its face opposite to said bead.

18. A tubular drive shaft, comprising a first section with a first diameter and a second section with a second diameter, said second diameter being smaller than said first diameter, and a transition section in which a diameter of said drive shaft diminishes from said first diameter to said second diameter and which is provided with an annular bead coaxially surrounding a longitudinal axis of said drive shaft, which is produced by a method according to any one of the previous claims.

19. The method according to claim 1, characterized in that said tubular drive shaft is a cardan shaft for a motor vehicle.

20. The tubular drive shaft according to claim 18, characterized in that said tubular drive shaft is a cardan shaft for a motor vehicle.
